(19) United States
(12) Patent Application Publication
(10) Pub. No.: US 2017/0192724 A1
(43) Pub. Date: Jul. 6, 2017

(54) PRINTING CONTROL METHOD OF HOST DEVICE CONNECTED TO IMAGE FORMING DEVICE AND HOST DEVICE THEREOF

(71) Applicant: S-Printing Solution Co., Ltd., Suwon-si, Gyeonggi-do (KR)

(72) Inventors: Sung-jae KIM, Suwon-si (KR); Jae-wook CHO, Seoul (KR); Hong-seock KIM, Suwon-si (KR); Mi-kyung CHOI, Suwon-si (KR); Chang-seok CHOI, Suwon-si (KR)

(73) Assignee: S-Printing Solution Co., Ltd., Suwon-si, Gyeonggi-do (KR)

(21) Appl. No.: 15/314,352

(22) PCT Filed: Mar. 23, 2015
(86) PCT No.: PCT/KR2015/002803

§ 371 Date: Nov. 28, 2016

(30) Foreign Application Priority Data
May 30, 2014 (KR) 10-2014-0066369
Jun. 9, 2014 (KR) 10-2014-0069600
Oct. 6, 2014 (KR) 10-2014-0134079

(51) Int. Cl. G06F 3/12

(52) U.S. Cl. CPC G06F 3/1213; G06F 3/1229; G06F 3/1276; G06F 3/1296; G06F 3/1212

(57) ABSTRACT

A host device is disclosed. The host device comprises: an input unit for receiving a control command for performing a preset event; a communication interface unit for communicating with an image forming device; and a control unit for transmitting, to the image forming device via the communication interface unit, a state change command for changing an operating state of the image forming device and performing the preset event corresponding to the received control command, if the received control command is a command related to controlling the image forming device.

### TECHNICAL FIELD

The present invention relates to a printing control method of a host device connected to an image forming device and a host device thereof, and more particularly, to a host device which controls an image forming device to enter a printing ready state in advance prior to transmitting printing data, and a printing control method thereof.

### BACKGROUND ART

In general, an image forming device refers to a device which prints printing data generated in a terminal device such as a computer on recording paper. Examples of such an image forming device are a copier, a printer, a facsimile machine, or a Multi-Function Peripheral (MFP) complexly implementing functions of the aforementioned devices through a single device.

According to a related-art printing method, after a printer driver is driven in a host device and a user finishes printing settings related to a printing method and selects a print button, printing data is transmitted to an image forming device. If the image forming device which receives the printing data is in a power saving state, in which power consumption can be minimized, the image forming device requires a predetermined time to enter a ready state to output the received printing data. For example, time is required to check inner engines of the printer and increase a fusing temperature to some degree. The time required to enter the ready state described above is referred to as First Paper Out Time (FPOT) and is an important factor influencing the specification of the image forming device.

That is, according to the related-art printing method, the image forming device enters the ready state only after the user finishes all printing settings and selects the print button. Therefore, there is inconvenience that the user should wait for a predetermined time until printing data is outputted. Accordingly, there is a need for a method for outputting which can solve the above-mentioned problem.

Recent image forming devices are provided with various functions and also have various sub functions thereunder in addition to printing, copying, scanning, and faxing functions. For example, image forming devices provide various sub functions according to users' various needs, such a function of collecting a plurality of documents and printing on a single sheet of paper, a function of making a pamphlet, a function of making a single post by printing on several sheets of paper, a scan quality adjustment function, a power-saving printing function, or the like.

However, in the related-art method, users should go through complicated steps to use these sub functions. For example, in order to use a duplex printing function, a user should select a print function menu on a menu screen first, and, when a screen having various functions belonging to the printing function and classified is displayed, the user should press many buttons one by one in order to enter a sort page including the duplex printing function.

Due to such a complicated menu screen configuration, users may not know what functions are included in the image forming device and most of the users may not expend time and effort in learning those functions. In addition, as the types of functions and providing methods thereof vary according to types of image forming devices, even a user who is accustomed to using the functions of a previous image forming device should learn new functions when the user buys a new image forming device. Accordingly, there is a need for an image forming device which is designed for users to easily recognize and use functions which are being advanced and are becoming more difficult to handle.

### DETAILED DESCRIPTION OF THE PRESENT INVENTION

### Technical Objects

The present invention has been developed in order to solve the above-mentioned problems, and an object of the present invention is to provide a host device which controls an image forming device to enter a printing ready state in advance prior to transmitting printing data, and a printing control method thereof.

In addition, another object of the present invention is to provide an image forming device which can analyze various job situations and appropriately provide a function according to a situation as a result of the analyzing, and an image forming method thereof.

### Technical Solving Method

According to an exemplary embodiment of the present invention to achieve the above-described object, a host device includes: an input unit which receives a control command for performing a predetermined event; a communication interface which communicates with an image forming device; and a controller which, in response to the received control command being related to control of the image forming device, transmits, to the image forming device via the communication interface, a state change command for changing the operation state of the image forming device, and performs the predetermined event corresponding to the received control command.

The predetermined event may be at least one of a driving event of a printer driver, a driving event of a predetermined application, a printer selection event, a print option setting event, and a printing file selection event.

The controller may generate printing data and transmit the generated printing data to the image forming device to which the state change command has been already transmitted via the communication interface.

In response to the predetermined event being the print option setting event, the controller may generate printing data reflecting the set print option.

In response to the predetermined event being the printer selection event, the controller may transmit the state change command to an image forming device corresponding to the selected printer.

The state change command may be a command for changing the operation state of the image forming device from a power saving state to a non-power saving state.

In response to a print command not being inputted within a predetermined time after the state change command has been transmitted, the controller may transmit a command for changing the operation state of the image forming device to a power saving state to the image forming device via the communication interface.

The controller may generate printing data for a pre-selected file before a print command is inputted.

In response to a plurality of files being pre-selected, the controller may generate printing data for a predetermined number of files from among the pre-selected plurality of files.

In response to the print command being inputted, the controller may generate printing data for files for which printing data has not been generated from among the pre-selected plurality of files.

According to an exemplary embodiment of the present invention, a printing control method of a host device connected with an image forming device includes: receiving a control command for performing a predetermined event; in response to the control command being related to control of the image forming device, transmitting, to the image forming device, a state change command for changing the operation state of the image forming device; and performing the predetermined event corresponding to the received control command.

The predetermined event may be at least one of a driving event of a printer driver, a driving event of a predetermined application, a printer selection event, a print option setting event, and a printing file selection event.

According to an exemplary embodiment of the present invention, the printing control method of the host device connected with the image forming device may further include: generating printing data; and transmitting the generated printing data to the image forming device to which the state change command has been transmitted.

In response to the predetermined event being the print option setting event, the generating the printing data may include generating printing data reflecting the set print option.

In response to the predetermined event being the printer selection event, the transmitting the state change command to the image forming device may include transmitting the state change command to an image forming device corresponding to the selected printer.

The state change command may be a command for changing the operation state of the image forming device from a power saving state to a non-power saving state.

According to an exemplary embodiment of the present invention, the printing control method of the host device connected with the image forming device may further include, in response to a print command not being inputted within a predetermined time after the state change command has been transmitted, transmitting a command for changing the operation state of the image forming device to a power saving state to the image forming device.

According to an exemplary embodiment of the present invention, the printing control method of the host device connected with the image forming device may further include generating printing data for a pre-selected file before a print command is inputted.

In response to a plurality of files being pre-selected, the generating the printing data may include generating printing data for a predetermined number of files from among the pre-selected plurality of files.

According to an exemplary embodiment of the present invention, the printing control method of the host device connected with the image forming device may further include, in response to the print command being inputted, generating printing data for files for which printing data has not been generated from among the pre-selected plurality of files.

According to an exemplary embodiment of the present invention, a recording medium stores a program for performing a printing control method of a host device connected with an image forming device, wherein the printing control method includes: receiving a control command for performing a predetermined event; in response to the control command being related to control of the image forming device, transmitting, to the image forming device, a state change command for changing the operation state of the image forming device; and performing the predetermined event corresponding to the received control command.

According to an exemplary embodiment of the present invention, an image forming device includes: a photographing unit which photographs a user and generates image data; a display which displays a menu screen; and a controller which determines whether the user carries a document or not using the image data, and controls the display to change a function menu displayed on the menu screen according to a result of the determining and display the function menu.

The controller may estimate a hand location of the user in the image data, and determine whether the user carries a document or not by detecting an object matching a shape of a document pre-stored from the estimated hand location.

In response to an object moving within a predetermined distance from the image forming device being detected, the photographing unit may photograph the object and generate the image data.

In response to it being determined that the user does not carry a document, the controller may control the display to display a first menu screen for receiving a control command related to a function which does not require a document, and, in response to it being determined that the user carries a document, the controller may control the display to display a second menu screen for receiving a control command related to a function which requires a document.

The controller may control the display to display a third menu screen for receiving control commands related to the function which does not require a document and the function which requires a document, and, in response to it being determined that the user does not carry a document, the controller may control the display to change the third menu screen to the first menu screen for receiving the control command related to the function which does not require a document, and display the first menu screen.

The controller may control the display to display the third menu screen for receiving the control commands related to the function which does not require a document and the function which requires a document, and, in response to it being determined that the user carries a document, the controller may control the display to change the third menu screen to the second menu screen for receiving the control command related to the function which requires a document, and display the second menu screen.

In response to a user being authenticated and printing data being pre-stored in an account corresponding to the authenticated user, the controller may control the display to display a fourth menu screen including a list of pre-stored printing data.

According to an exemplary embodiment of the present invention, the image forming device may further include a communication unit, and the controller may authenticate a user and perform a function requested by the authenticated user, and may determine whether a document used for performing the function or a document used for a job is stacked or not and notify a terminal device corresponding to the user of information of the stacked document via the communication unit according to whether the document is stacked or not.

According to an exemplary embodiment of the present invention, the image forming device may further include a flatbed and a photographing element disposed under the flatbed, and the controller may detect placement of a document on the flatbed, generate a photographing image on the entire area of the flatbed on which the document is laid using the photographing element, calculate a size of the document relative to the size of the flatbed using the generated photographing image, analyze the type of the document based on the result of the calculating, and control the display to change a function menu displayed on the menu screen according to the result of the determining and the type of the document and display the function menu.

According to an exemplary embodiment of the present invention, the image forming device may further include an Automatic Document Feeder (ADF), and the controller may detect the height of a document laid on the ADF and control the display to change the function menu displayed on the menu screen according to the result of the determining and the height of the document and display the function menu.

In this case, the controller may detect the height of the document using a plurality of proximity sensors which are arranged in the vertical direction, or a gravity sensor for detecting the weight of a document.

The controller may receive settings of an option policy, and in response to printing data being received, perform a printing job by reflecting the set option policy.

In this case, the set option policy may be applied only within a predetermined time.

According to an exemplary embodiment of the present invention, an image forming method of an image forming device includes: photographing a user and generating image data; determining whether the user carries a document or not using the image data; and changing a function menu displayed on a menu screen according to a result of the determining and display the function menu.

The determining may include estimating a hand location of the user in the image data, and detecting an object matching a shape of a document pre-stored from the estimated hand location.

The displaying may include, in response to it being determined that the user does not carry a document, displaying a first menu screen for receiving a control command related to a function which does not require a document, and, in response to it being determined that the user carries a document, displaying a second menu screen for receiving a control command related to a function which requires a document.

According to an exemplary embodiment of the present invention, the image forming method of the image forming device may further include: authenticating a user; performing a function requested by the authenticated user; determining whether a document used for performing the function or a document used for a job is stacked or not; and notifying a terminal device corresponding to the user of information of the stacked document according to whether the document is stacked or not.

According to an exemplary embodiment of the present invention, the image forming method of the image forming device may further include: detecting placement of a document on a flatbed; generating a photographing image on the entire area of the flatbed on which the document is laid using a photographing element disposed under the flatbed; calculating a size of the document relative to the size of the flatbed using the generated photographing image; and analyzing the type of the document based on the result of the calculating, and the displaying may include changing a function menu displayed on the menu screen according to the result of the determining and the type of the document and displaying the function menu.

According to an exemplary embodiment of the present invention, the image forming method of the image forming device may further include detecting the height of a document laid on an ADF, and the displaying may include changing the function menu displayed on the menu screen according to the result of the determining and the height of the document and displaying the function menu.

According to an exemplary embodiment of the present invention, the image forming method of the image forming device may further include: receiving settings of an option policy; and in response to printing data being received, performing a printing job by reflecting the set option policy.

### Advantageous Effect

According to various exemplary embodiments described above, user's inconvenience of having to wait for a predetermined time until first paper is outputted can be minimized. In addition, the user can easily access various functions provided by the image forming device without going through complicated steps, and can be provided with an appropriate function according to various situations.

### BRIEF DESCRIPTION OF THE DRAWINGS

FIG. 1 is a block diagram to illustrate a host device according to an exemplary embodiment of the present invention;

FIG. 2 is a view to illustrate an operation state change of an image forming device according to an exemplary embodiment of the present invention;

FIGS. 3 and 4 are views to illustrate a method for transmitting, by a host device, a state change command to an image forming device according to various exemplary embodiments of the present invention;

FIGS. 5 to 8 are views to illustrate a method for generating printing data in a host device according to various exemplary embodiments of the present invention;

FIG. 9 is a flowchart to illustrate a printing control method of a host device connected with an image forming device according to an exemplary embodiment of the present invention;

FIG. 10 is a block diagram to illustrate an image forming device according to an exemplary embodiment of the present invention;

FIG. 11 is a view to illustrate a photographing unit of an image forming device according to an exemplary embodiment of the present invention;

FIGS. 12 and 13 and FIG. 15 are views to illustrate a menu screen which is provided by an image forming device according to various exemplary embodiments of the present invention;

FIG. 14 is a view to illustrate user authentication performed by an image forming device according to an exemplary embodiment of the present invention;

FIG. 16 is a view to illustrate various functions which are provided by an image forming device according to an exemplary embodiment of the present invention;

FIG. 17 is a view to illustrate a flatbed of an image forming device according to an exemplary embodiment of the present invention; and

FIG. 18 is a view to illustrate an image forming method of an image forming device according to an exemplary embodiment of the present invention.

### BEST MODE FOR EMBODYING THE INVENTION

### Mode for Embodying the Invention

Hereinafter, the present invention will be described in detail herein below with reference to the accompanying drawings. In the following description, well-known functions or constructions are not described in detail since they would obscure the invention in unnecessary detail.

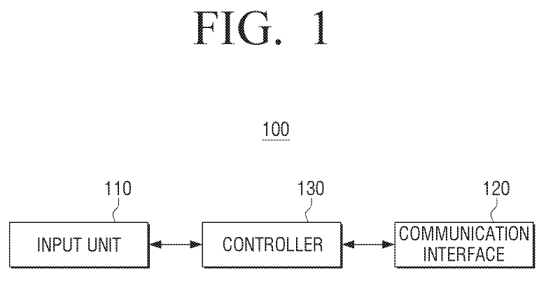

FIG. 1 is a block diagram to illustrate a host device 100 according to an exemplary embodiment of the present invention. Referring to FIG. 1, the host device 100 includes an input unit 110, a communication interface 120, and a controller 130.

The host device 100 may be a desktop computer, a notebook computer with a display unit, or a mobile device such as a mobile phone, a smart phone, or a tablet PC.

The host device 100 may have a printer driver, which is software for generating printing data, installed therein, and the host device 100 may communicate with an image forming device 200 using the printer driver, generate printing data by converting a print command into a language which can be understood by the image forming device 200, instruct the image forming device 200 what to do regarding a command, and manage a job which is performed by the image forming device 200.

The input unit 110 is configured to receive various control commands for controlling the host device 100 from a user. In particular, the input unit 110 may receive a control command for performing a predetermined event. For example, the input unit 110 may be an input device such as a keyboard or a mouse or may be a touch screen combined with a display. However, this should not be considered as limiting.

The communication interface 120 is configured to allow the host device 100 to communicate with another external device, and may transmit printing data or the like to the image forming device 200 or may receive state information or the like from the image forming device 200. In particular, a state change command may be transmitted to the image forming device 200 via the communication interface 120. The state change command will be described in detail below.

The communication interface 120 may communicate with various types of external devices according to various communication methods, and for example, may include various communication chips such as a WiFi chip, a Bluetooth chip, a Near Field Communication (NFC) chip, and a wireless communication chip. The WiFi chip, the Bluetooth chip, and the NFC chip communicate in a WiFi method, a Bluetooth method, and an NFC method, respectively. The NFC chip refers to a chip which operates in an NFC method using a band of 13.56 MHz from among various RF-ID frequency bands such as 135 kHz, 13.56 MHz, 433 MHz, 860-960 MHz, and 2.45 GHz. When the WiFi chip or the Bluetooth chip is used, a variety of connection information such as an SSID and a session key may be exchanged first, and communication may be established using the connection information, and then a variety of information may be exchanged. The wireless communication chip refers to a chip which communicates according to various communication standards such as IEEE, Zigbee, 3^{rd} Generation (3G), 3rd Generation Partnership Project (3GPP), Long Term Evolution (LTE), and the like.

The controller 130 is configured to control an overall operation of the host device 100.

In particular, in response to a control command received via the input unit 110 being related to control of the image forming device 200, the controller 130 may transmit a state change command for changing the operation state of the image forming device 200 to the image forming device 200 via the communication interface 120.

Herein, the state change command may be a command for changing the operation state of the image forming device 200 from a power saving state to a non-power saving state, that is, to a ready state. That is, in response to the control command related to control of the image forming device 200 being detected even before a print command is inputted, the controller 130 may wake up the image forming device 200 which is in the power-saving state.

To the contrary, when the image forming device 200 is in the non-power saving state, the state change command may be a command for changing the state of the image forming device 200 from the non-power saving state to the power saving state.

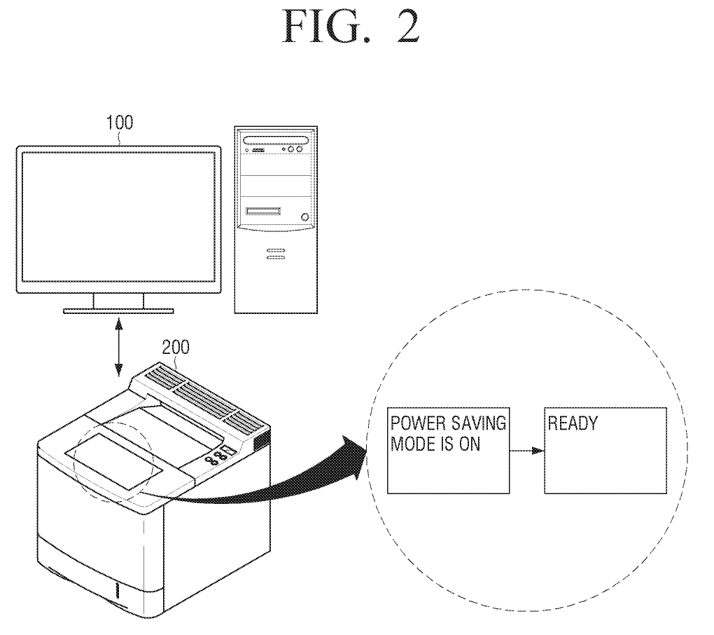

Referring to FIG. 2, in response to the state change command being received from the host device 100, the image forming device 200 changes its state from the power-saving state to the non-power saving state, that is, the ready state. By doing so, the image forming device 200 is already in the ready state before the print command is inputted from the host device 100, and can perform an output job at the same time as receiving printing data from the host device 100, such that the First Paper Out Time (FPOT) can be greatly reduced.

The control command related to the control of the image forming device 200 may be a command for performing, by the host device 100, a predetermined event, and the predetermined event may be at least one of a driving event of the printer driver, a driving event of a predetermined application, a printer selection event, a print option setting event, and a printing file selection event. Hereinafter, the respective events will be described in detail.

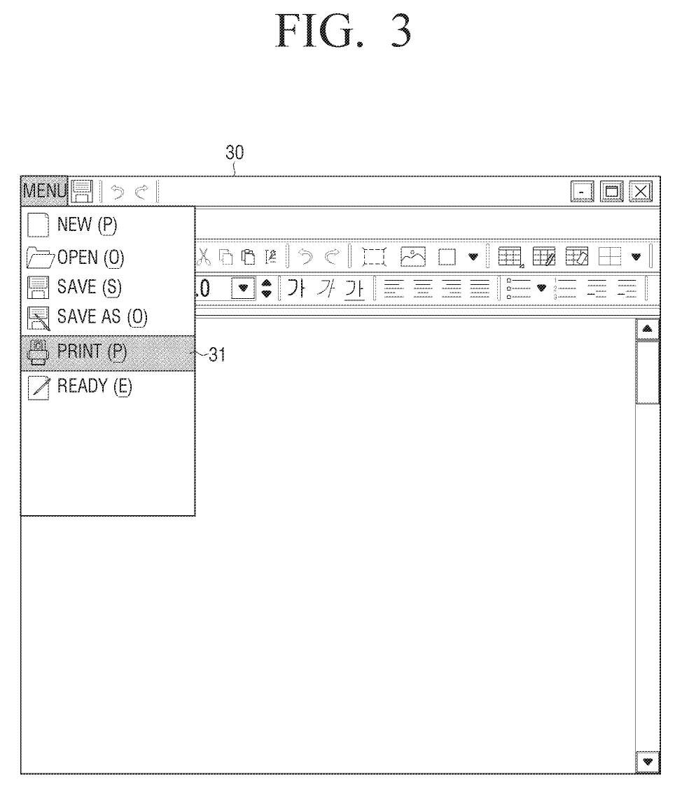

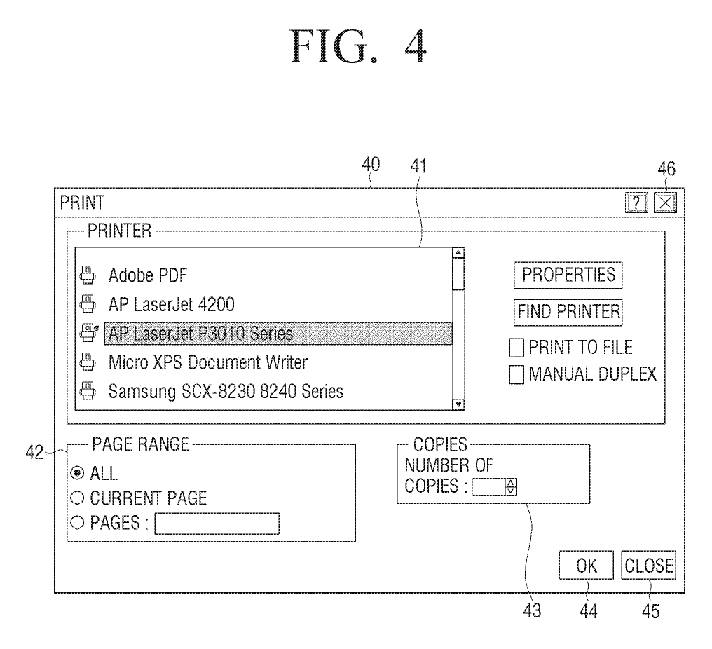

Specifically, the printer driver stored in the host device 100 may be driven in response to a print menu being selected. For example, as shown in FIG. 3, in response to a document creation program being executed, a window 30 including various menus for creating or editing a document or the like is displayed. In response to a user creating a document and selecting a print menu 31 on the menu to output the document, the printer driver is driven and accordingly a print option input window (print dialog window) is displayed as shown in FIG. 4. According to the exemplary embodiment, at the time when the printer driver is driven, the controller 130 transmits the state change command to the image forming device 200.

In another example, the state change command may be transmitted to the image forming device 200 at the time when a predetermined application stored in the host device 100 is driven. Specifically, in response to the user of the host device 100 setting the specific image forming device 200 to be in charge of the outputting of printing data, the controller 130 may transmit the state change command to the specific image forming device 200 at the same time as driving a print application in the host device 100.

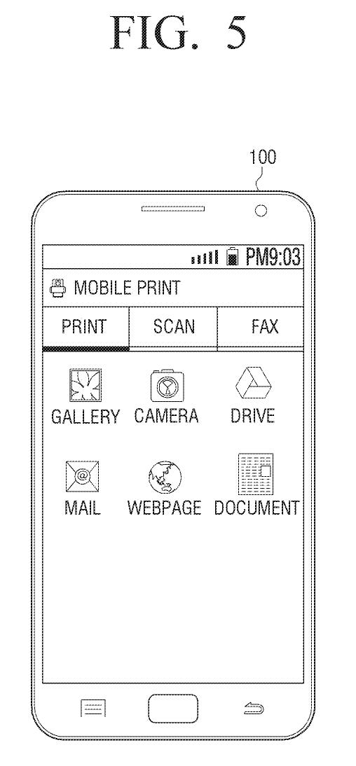

FIG. 5 illustrates an example of a screen which is displayed in response to a print application being executed when the host device 100 is implemented by using a mobile device, for example, a smart phone. At the same time as executing the print application, the controller 130 may transmit the state change command to the image forming device 200. However, after the print application is executed and the state change command is transmitted, in response to a power saving button provided on the screen being selected although not shown, the controller 130 may transmit a command for changing the state of the image forming device 200 from the non-power saving state to the power saving state to the image forming device 200. That is, when the user does not have an intention to print after the print application is performed, the image forming device 200 can be returned to the power saving state.

According to another exemplary embodiment, in response to a wireless connection link being formed between the host device 100 and the image forming device 200, the controller 130 may transmit the state change command to the image forming device 200. For example, the communication interface 120 may communicate with the image forming device 200 using an NFC chip, and in response to a tagging operation being achieved between the host device 100 and the image forming device 200, the wireless connection link may be formed between both devices.

That is, according to the exemplary embodiment, at the same time as the tagging operation is performed, the controller 130 may transmit the state change command to the image forming device 200. However, this should not be considered as limiting. In response to the wireless connection link being formed (for example, in response to NFC tagging being detected), the image forming device 200 may change its state to the ready state without receiving the state change command. The wireless connection link may be formed in various wireless communication methods, such as WiFi, Bluetooth, or the like, in addition to the NFC method.

According to another exemplary embodiment, in response to a control command for selecting a printer to perform a print job being inputted, the controller 130 may transmit the state change command to the image forming device 200. Hereinafter, an example of a control command input for selecting a printer will be described with reference to FIG. 4.

FIG. 4 illustrates an example of a print option window 40 which is displayed in response to the printer driver being driven. As described through FIG. 3, the print option window 40 may be displayed in response to the print menu being selected. Through the print option window 40, the user may set detailed print options, and in particular, may select a printer to print. In addition, the controller 130 may generate printing data reflecting the set print options.

The print option window 40 may include a list of printers 41 connected to the host device 100, and, in response to a printer being selected from the list to perform a printing job, the controller 130 may transmit the state change command to the image forming device 200 corresponding to the selected printer.

In response to the selection of the printer being changed, the controller 130 may transmit the state change command for changing the state to the non-power saving state (ready state) to an image forming device corresponding to the newly selected printer, and may transmit the state change command for changing the state back to the power saving state to the image forming device corresponding to the deselected printer.

Alternatively, in response to a command for canceling the setting of the print option being inputted, for example, in response to a cancel menu 45 or a window close menu 46 shown in FIG. 4 being selected, the controller 130 may transmit a command for changing the operation state back to the power saving state to the image forming device 200 to which the state change command has been already transmitted.

Alternatively, in response to a printing command not being inputted within a predetermined time after the state change command for changing the state of the image forming device 200 to the non-power saving mode has been transmitted, the controller 130 may transmit the command for changing the operation state of the image forming device 200 back to the power saving state to the image forming device 200 without receiving a separate command.

Various print options may be provided according to the type of the printer driver. In response to at least one option being set from among the print options, the controller 130 may transmit the state change command to the image forming device 200. For example, at the time when an option regarding a range of a page to be printed is set on a page range option 42 or at the time when the number of copies to be printed is set on a copies option 43 as shown in FIG. 4, the controller 130 may transmit the change state command to the image forming device 200. That is, according to various exemplary embodiments of the present invention, in response to any control command being inputted from among various control commands related to the control of the image forming device 200, the control command may serve as a trigger for waking up the image forming device 200.

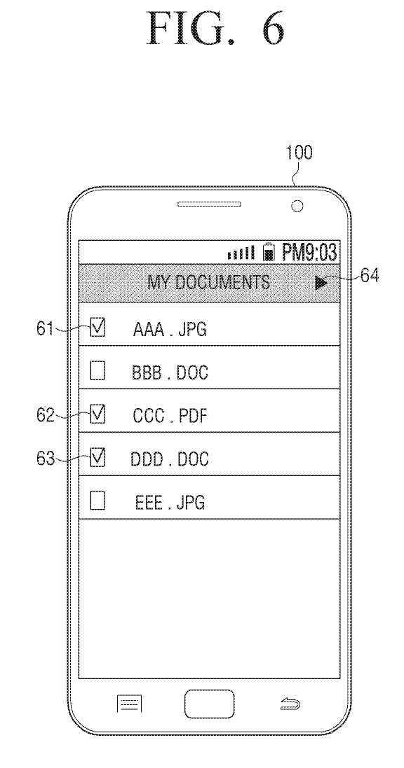

According to another exemplary embodiment of the present invention, in response to a control command for performing a selection event of a printing file being inputted, the controller 130 may transmit the state change command to the image forming device 200. This embodiment will be described with reference to FIGS. 5 and 6.

FIG. 5 is a view to illustrate a case in which a print application is executed when the host device 100 is implemented by using a mobile device.

In response to the print application being executed, various menus through which a printing file is selected may be displayed as shown in FIG. 5. For example, a menu for opening a gallery folder in which pre-stored image files exist, a menu for driving a camera, a menu for accessing a user account of a server, a menu for opening a mail box, a menu for loading a page of a specific web address, a menu for opening a folder in which pre-stored document files exist, and the like may be displayed, and the user may select one of these menus according to the purpose of printing.

In response to the user selection being inputted, a list of files may be displayed as shown in FIG. 6 and the user may select a file to be printed from the list. At the same time as the file to be printed is selected, the controller 130 may transmit the state change command to an image forming device with which a wireless connection link is formed or an already-determined image forming device.

In this case, according to an exemplary embodiment of the present invention, at the time when the printing file is selected before a print command is inputted, the controller 130 may generate printing data for the selected file. For example, referring to FIG. 6, in response to printing files 61, 62, 63 being selected, the controller 130 may apply a default print option to the selected printing files 61, 62, 63 and generate printing data. Accordingly, when the host device 100 is a mobile device which requires relatively long time to render printing data, the host device 100 can render in advance and thus can shorten the time for outputting. The rendering recited herein refers to an operation of processing data to be printed so as to be recognized by the image forming device 200.

Specifically, according to a printing method of a normal mobile device, in response to a next button 64 being selected to proceed to the next step after printing files 61, 62, 63 are selected, the controller 130 may output preview images of the printing files and receive print option settings through the input unit 110. According to such a related-art printing method, printing data is generated only after the user views the preview images, finishes setting the print option, and then inputs a print command. However, according to the present exemplary embodiment, the rendering operation is performed during the time when the preview images are generated and the print option is inputted, and printing data can be generated in advance. As a result, the FPOT can be reduced. For example, in this embodiment, at the time when the next button 64 is selected to proceed to the next step, the printing data for the selected printing files may be generated. Alternatively, the printing data of each printing file may be generated every time each printing file is generated.

According to another exemplary embodiment of the present invention, the controller 130 may apply a default print option only to a predetermined number of files from among the selected printing files and generate printing data, and, in response to the setting of the print option being finished and a print command being inputted, may generate printing data for the other files for which printing data has not been generated.

This is to generate printing data only for some files in advance in case that the user sets a print option different from the default print option. Accordingly, the number of printing files for generating printing data in advance may be one. When the user wishes to follow the default print option as it is, the already generated printing data may be useful to reduce the FPOT.

In response to a print option different from the default print option being set by the user, the controller 130 may change the already generated printing data or may newly re-generate printing data according to the set print option.

According to another exemplary embodiment of the present invention, the controller 130 may detect an order in which the printing files are selected and generate printing data for a predetermined number of printing files in advance. For example, in response to the predetermined number of printing files being one, the controller 130 may apply the default print option only to the initially selected file and generate printing data in advance. In response to the predetermined number of printing files being two, the controller 130 may apply the default print operation to the initially selected file and the next file, and generate the printing data in advance.

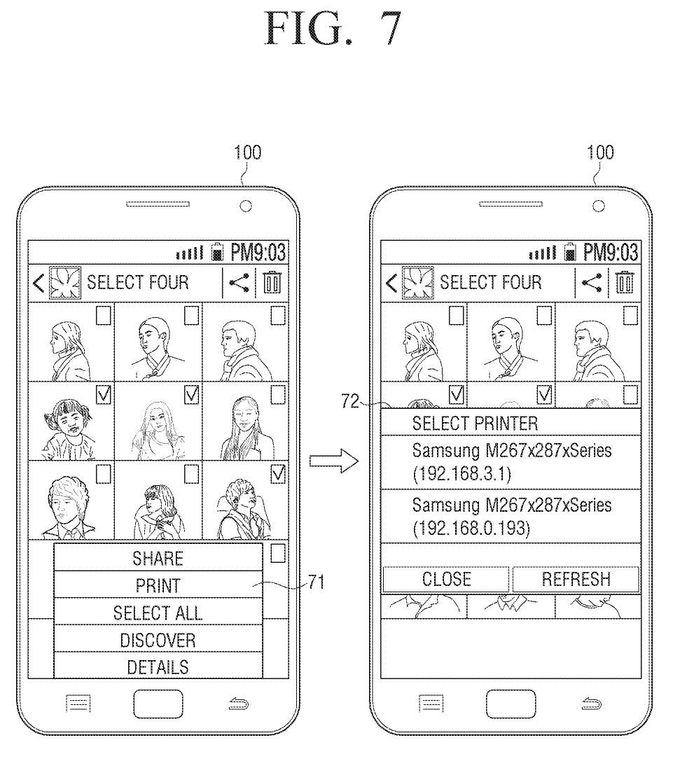

In the above description, the exemplary embodiment in which the printing files are selected after the print application is executed has been described with reference to FIGS. 5 and 6. However, according to another exemplary embodiment of the present invention, the printing files may be selected before the print application is executed. Hereinafter, this embodiment will be described in detail with reference to FIG. 7.

Referring to FIG. 7, in response to a plurality of files being selected and then a menu related to processing of the selected files being selected, a menu window including a print menu 71 may be displayed. In this case, in response to the print menu 71 being selected, the controller 130 may transmit the state change command to the predetermined image forming device 200 and thereby change the state of the image forming device 200 to the non-power saving state as described above.

According to another exemplary embodiment, in response to the print menu 71 being selected, a printer selection window 72 including a list of printers connected to the host device 100 may be displayed as shown in FIG. 7. In this case, in response to a specific printer being selected from the list of printers by the user, the controller 130 may transmit the state change command to the image forming device 200 corresponding to the selected printer.

In the exemplary embodiments described above with reference to FIG. 7, after selecting printing files, the user may set a print option to be applied to the printing files and input a print command. Before the print command is inputted, the controller 130 may apply the default print option to the selected printing files and generate printing data in advance.

For example, in response to the print menu 71 being selected as shown in FIG. 7, the controller 130 may apply the default print option to the selected files and generate printing data in advance. In this case, the printing data may be generated only with respect to a predetermined number of files in advance. Alternatively, printing data may be generated with respect to the selected files at the time when a printer to print is selected on the printer selection window 72.

In this case, the controller 130 may detect an order in which files are selected and generate printing data only with respect to a predetermined number of files according to the order of selecting. For example, in response to the predetermined number of files being one, the controller 130 may apply the default print option only to the initially selected file and generate printing data in advance.

Thereafter, in response to a print command being inputted, the controller 130 may generate printing data for the other files for which printing data has not been generated. The method for generating printing data described above is the same as described through FIG. 6, and thus a redundant explanation is omitted.

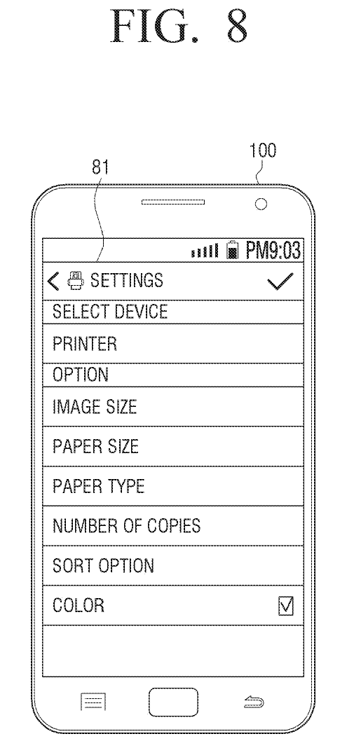

After the printing files are selected as described above, a screen 81 for selecting a print option to be applied to the selected files may be displayed through the display as shown in FIG. 8. The host device 100 may basically provide the default print option and then the user may set a different print option by changing the default option.

In response to the print option set by the user being different from the default print option, the controller 130 may change the already generated printing data according to the set print option or may newly regenerate printing data. In response to the user inputting a print command without changing the default print option, the controller 130 may apply the default print option to the other files for which printing data has not been generated, and generate printing data.

According to various exemplary embodiments described above, printing data can be generated in advance before a print command is inputted, and also, the image forming device 200 in the power-saving state can be prepared in the non-power saving state in advance. Therefore, the FPOT can be greatly reduced.

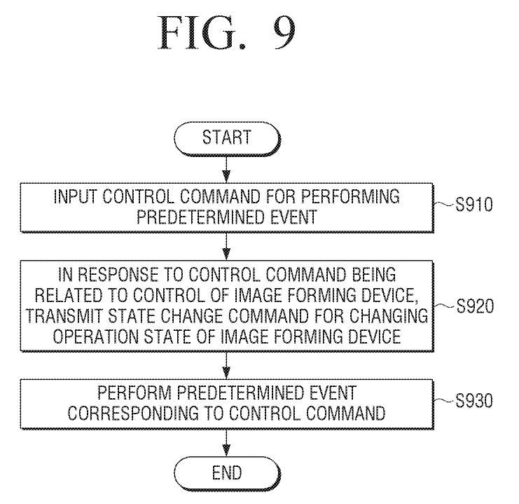

FIG. 9 is a view to illustrate a printing control method of the host device connected to the image forming device according to an exemplary embodiment of the present disclosure.

Referring to FIG. 9, the host device 100 may receive a control command for performing a predetermined event first (S910). Herein, the predetermined event may be at least one of a driving event of a printer driver, a driving event of a predetermined application, a printer selection event, a print option setting event, and a printing file selection event as described above.

In response to the received control command being related to control of the image forming device 200, the controller 130 may transmit a state change command for changing the operation state of the image forming device 200 to the image forming device 200 via the communication interface 120 (S920). In this case, the state change command may be a command for changing the operation state of the image forming device 200 from a power saving state to a non-power saving state or may be a command for changing the non-power saving state to the operation state.

In response to the predetermined event being the print option setting event, the controller 130 may generate printing data reflecting the set print option. Alternatively, in response to the predetermined event being the printer selection event, the controller 130 may transmit the state change command to the image forming device 200 corresponding to the selected printer.

The controller 130 performs the predetermined event corresponding to the received control command (S930).

After performing the predetermined event according to the received control command or at the same time as performing the predetermined event, the controller 130 may transmit the generated printing data to the image forming device 200 to which the state change command has been transmitted. In this case, the transmitted printing data may be data which has been already generated before the print command is inputted according to the above-described various exemplary embodiments.

In response to a print command not being inputted within a predetermined time after the state change command has been transmitted, the controller 130 may transmit a command for changing the operation state of the image forming device 200 to the power saving state to the image forming device 200.

In addition to the above-described printing control methods, various printing control methods of the host device 100 according to various exemplary embodiments described with reference to FIGS. 1 to 8 can be derived. Accordingly, a redundant explanation of such printing control methods is omitted.

The printing control method of the host device connected to the image forming device according to the above-described various exemplary embodiments may be stored in a non-transitory readable medium. The non-transitory readable medium may be mounted and used in various devices.

The non-transitory readable medium refers to a medium that stores data semi-permanently rather than storing data for a very short time, such as a register, a cache, and a memory, and is readable by an apparatus. Specifically, the non-transitory readable medium may be a compact disc (CD), a digital versatile disk (DVD), a hard disk, a Blu-ray disk, a universal serial bus (USB), a memory card, and a read only memory (ROM).

Hereinafter, exemplary embodiments of the present invention will be described in more detail with reference to the accompanying drawings. In the following description, well-known functions or constructions are not described in detail since they would obscure the invention in unnecessary detail.

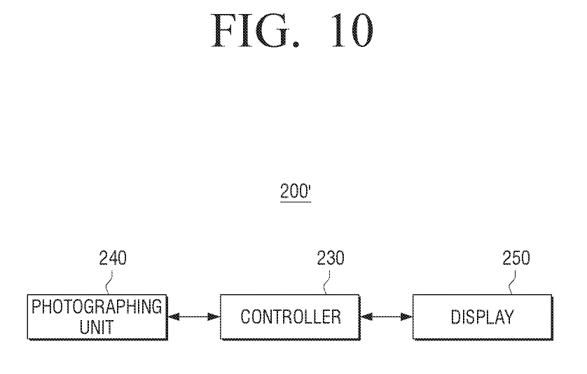

FIG. 10 is a block diagram to illustrate an image forming device according to another exemplary embodiment of the present invention.

Referring to FIG. 10, the image forming device 200′ includes a photographing unit 240, a display 250, and a controller 230.

The photographing unit 240 may be disposed on one surface of the image forming device 200′ and configured to photograph an object approaching the image forming device 200′, and the photographing unit 240 may generate image data by photographing a user approaching the image forming device 200′.

For example, the photographing unit 240 may be implemented by using a camera unit including a lens and an image sensor. In this case, the controller 230 may detect a specific portion from the image or video photographed by the photographing unit 240 and may determine whether the user carries a document or not.

In particular, in response to an object moving within a predetermined distance from the image forming device 200′ being detected, the photographing unit 240 may photograph the object and generate image data.

According to an exemplary embodiment, the photographing unit 240 is normally in an off state, and, in response to an object entering within a predetermined distance from the image forming device 200′ being detected through an infrared sensor (not shown) provided in the image forming device 200′, the photographing unit 240 may photograph the object.

The display 250 is configured to display a screen including at least one object. Herein, the screen refers to an image frame which is provided by the image forming device 200′ through the display 250. Specifically, the screen may include a home screen, a menu screen, an icon screen, a list screen, an application execution screen, a web browser screen, a content reproduction screen, or the like. In addition, the object refers to various shapes which are displayed in the screen, such as an icon, a function menu, a text, a photo, a widget, or the like.

The display 250 may be implemented by using various kinds of displays such as a Liquid Crystal Display (LCD), an Organic Light Emitting Diodes (OLED) display, a Plasma Display Panel (PDP), or the like. The display 250 may include a driving circuit which is implemented in the form of an a-si TFT, a Low Temperature Poly Silicon (LTPS) TFT, an organic TFT (OTFT), or the like, a backlight unit, or the like. In addition, the display 250 may be implemented by using a touch screen with a sensor (not shown).

In particular, the display 250 may change and display a function menu displayed on the menu screen under the control of the controller 230. Specifically, the menu screen may be a screen for receiving a control command related to a function provided by the image forming device 200′, and may include a plurality of function menus. For example, when the display 250 is implemented by using a touch panel, in response to a user's touch being detected on a region on which a specific function menu is displayed on the menu screen, a corresponding function may be executed.

The image forming device 200′ may provide various functions and the display 250 may display various menu screens including different function menus according to various conditions. For example, in response to the controller 230 determining that the user carries a document using image data photographed by the photographing unit 240, the display 250 may display a menu screen for receiving a control command related to a function which requires a document, under the control of the controller 230. To the contrary, in response to the controller 230 determining that the user does not carry a document using image data photographed by the photographing unit 240, the display 250 may display a menu screen for receiving a control command related to a function which does not require a document, under the control of the controller 230.

For example, the function which requires a document may be a copy function, a scan function, a fax function, or the like, and the function which does not require a document may be a function of printing a file stored in a portable storage medium, a function of printing a file stored in a server, a function of printing a file stored in a user account, or the like.

In addition, the display 250 may display a menu screen for receiving a control command related to both the function which requires a document and the function which does not require a document, under the control of the controller 230.

In addition, the image forming device 200′ may include an Automatic Document Feeder (ADF) which is in charge of automatic input of a document, and the ADF may be provided with a sensor for sensing the height of a document. The controller 230 may control the display 250 to display a screen including function menus related to functions which are used to scan or copy a plurality of documents according to the height of a document (for example, a function of collecting several sheet of a document and printing on a single sheet of paper).

In addition, the image forming device 200′ may authenticate the user, and, in response to printing data being pre-stored in an account corresponding to the authenticated user, the display 250 may display a screen including a list of pre-stored printing data under the control of the controller 230.

Herein, the printing data is printing data which has been transmitted from a host device 100′, and may include information on the user of the host device 100′. Thereafter, in response to the same user being authenticated by the image forming device 200′, the screen including the list of printing data of the user may be displayed through the display 250.

According to various exemplary embodiments of the present invention described above, the display 250 may display various screens according to circumstances. Hereinafter, various screens will be described in detail with reference to the drawings.

The controller 230 may be configured to control the overall operation of the image forming device 200′.

In particular, the controller 230 may determine whether a user carries a document or not using image data of the user which is photographed by the photographing unit 240. A specific object may be detected from the image data in various related-art methods. For example, the controller 230 may analyze image data, generate edge information and color information on the object, distinguish body parts of the user according to the generated information, and then estimate the location of the user's hand.

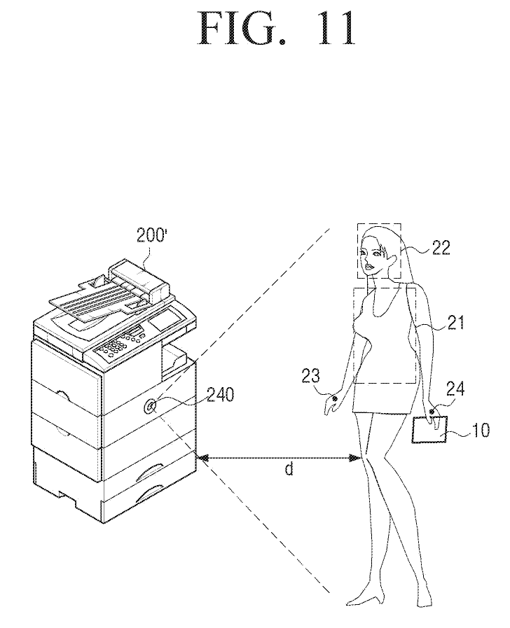

Specifically, referring to FIG. 11, in response to an object (herein, a user) moving within a predetermined distance d being detected, the controller 230 photographs the object through the photographing unit 240 and generates image data. The controller 230 may detect a characteristic body which is easy to detect from the generated image data, for example, a body part 21 or a head part 22 of the user, and may estimate locations 23 and 24 of both hands of the user by applying average body proportion information or movement range angle information of arms of human beings with reference to the detected part.

In addition, the controller 230 detects an object 10 matching a shape of a document pre-stored from the estimated locations of the user's hands. For example, the shape of the document pre-stored may be a rectangular shape having an area of a specific range. The accuracy of matching may be enhanced by further using a color matching method in addition to the shape matching method. Specifically, the controller 230 may determine whether there exists a white object in the estimated locations of the hands, and determine whether the edge of the white object matches the shape of the document pre-stored.

The above-described exemplary embodiment is merely one of the image data analyzing methods and various related-art image data analyzing techniques can be applied. Therefore, an explanation of various related-art methods is omitted.

In addition, the controller 230 may determine whether the user carries the document or not by analyzing the image data, and may control the display 250 to change and display a function menu displayed on a menu screen according to a result of the determining. That is, the controller 230 may determine whether the user carries the document or not and control the display 250 to display a menu screen including only a function menu of a function suited to a situation.

The image forming device 200′ may perform various image forming jobs, and a function which uses a document from among these may be copying, printing, faxing, or the like. In addition, a function which does not use a document may be a function of receiving printing data and outputting, a function of printing a file stored in a server or a portable storage medium, or the like. According to the present embodiment, the user may be provided with a necessary function by simply approaching the image forming device 200′ without inputting a separate input.

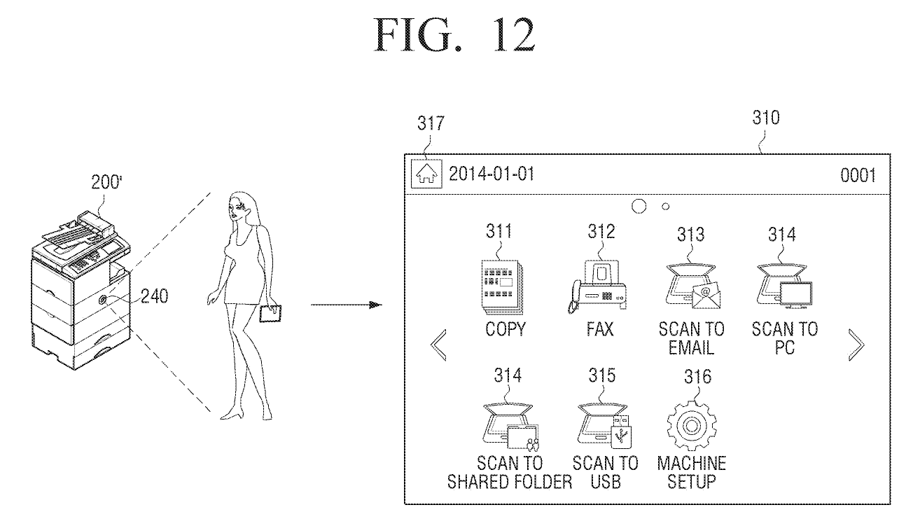

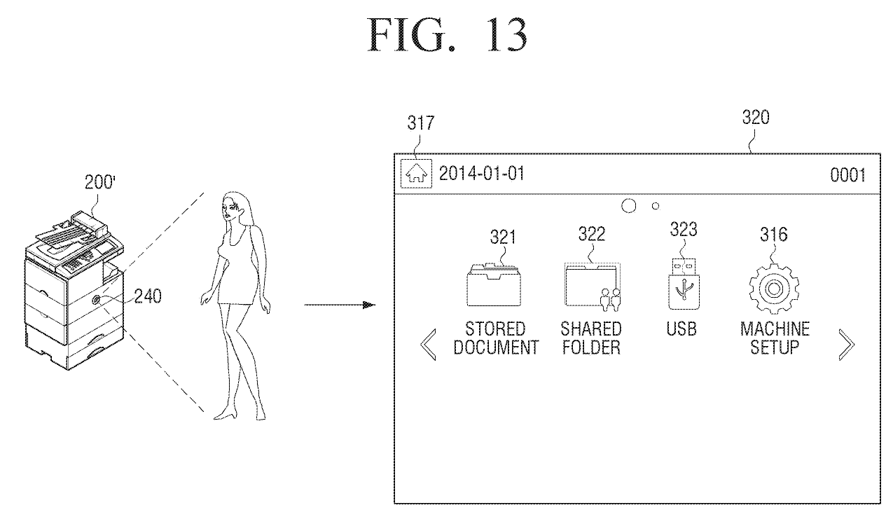

Specifically, in response to it being determined that the user does not carry a document, the controller 230 may control the display 250 to display a menu screen for receiving a control command related to the function which does not require a document, and, in response to it being determined that the user carries a document, the controller 230 may control the display 250 to display a menu screen for receiving a control command related to the function which requires a document. Hereinafter, various menu screens will be described with reference to FIGS. 12 and 13.

FIG. 12 is a view to illustrate a menu screen which is displayed on the display 250 according to an exemplary embodiment of the present invention.

Referring to FIG. 12, in response to it being determined that a user carries a document using image data photographed by the photographing unit 240, the controller 230 may control the display 250 to display a menu screen 310 for receiving a control command related to the function which requires a document.

The menu screen 310 may include function menus which require a document, such as a copy function menu 311, a fax function menu 312, a scan to email function menu 313, a scan to PC function menu 318, a scan to shared folder function menu 314, a scan to USB function menu 315, or the like. In addition, the menu screen 310 may include a setting function menu 316.

In response to a home button 317 provided on the menu screen 310 being selected, the controller 230 may control the display 250 to display a menu screen which displays all of the function menus related to the function which does not require a document as well as the function which requires a document.

In response to a function menu displayed on the menu screen 310 being selected, a menu screen including function menus related to specific functions which are provided by the corresponding function may be displayed on the display 250.

FIG. 13 is a view to illustrate a menu screen which is displayed on the display 250 according to another exemplary embodiment of the present invention.

Referring to FIG. 13, in response to it being determined that a user does not carry a document using image data photographed by the photographing unit 240, the controller 230 may control the display 250 to display a menu screen 320 for receiving a control command related to the function which does not require a document.

The menu screen 320 may include function menus which do require a document, such as a menu 321 for printing a stored document, a menu 322 for printing a file stored in a shared folder, a menu 323 for printing a file stored in a USB, or the like.

In response to the home button 317 provided on the menu screen 320 being selected, the controller 230 may control the display 250 to display the menu screen which displays all of the function menus related to the function which does not require a document as well as the function which requires a document.

In response to a function menu being selected from the function menus displayed on the menu screen 320, a menu screen including specific function menus may be displayed on the display 250.

The function menus illustrated in FIGS. 12 and 13 are merely examples of function menus corresponding to the function which requires a document or the function which does not require a document, and the functions provided by the image forming device 200′ are not limited to the function menus illustrated in FIGS. 12 and 13.

According to another exemplary embodiment of the present invention, before a user approaches the image forming device 200′, the controller 230 may control the display 250 to display a menu screen (a third menu screen) for receiving control commands related to the function which does not require a document and the function which requires a document. After the user approaches the image forming device 200′, in response to it being determined that the user does not carry a document, the controller 230 may control the display 250 to change the third menu screen to a menu screen (first menu screen) for receiving a control command related to the function which does not require a document. In response to it being determined that the user carries a document, the display 250 may maintain the third menu screen as it is. That is, only in response to it being determined that the user does not carry a document, the controller 230 may change the screen.

In response to it being determined that the user carries a document, the controller 230 may control the display 250 to change the third menu screen to a menu screen (second menu screen) for receiving a control command related to the function which requires a document.

The image forming device 200′ may authenticate a user, and users' respective accounts may be provided in the image forming device 200′ or an external device. When many people use a single image forming device 200′, printing data transmitted from users' respective computers to the image forming device 200′ may be stored in users' respective accounts, and then, in response to user authentication being achieved in the image forming device 200′, the printing data may be outputted.

In this case, the user may log in to the user's account by inputting an ID and a password to the image forming device 200′ or may log in by tagging the user's ID card on a terminal device provided on the image forming device 200′. Alternatively, the user may log in in various recognition methods such as fingerprint recognition, iris recognition, voice recognition, or the like.

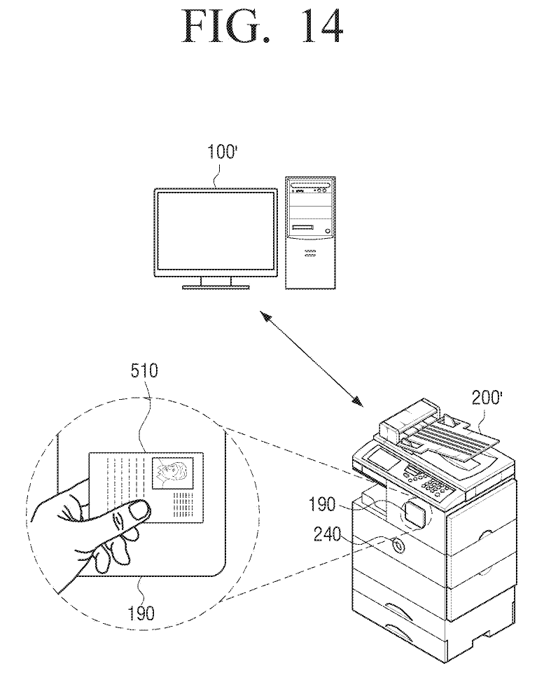

FIG. 14 is a view to illustrate a user authentication method of the image forming device 200′ according to an exemplary embodiment of the present invention.

The image forming device 200′ may include an ID card recognition unit 190 and a communication interface (not shown) to communicate with the host device 100′.

In response to an ID card 510 being tagged on the ID card recognition unit 190, the ID card recognition unit 190 may read out data contained in the ID card, and the controller 230 may authenticate the user using the read-out data.

The tagging recited herein refers to an action which allows the ID card 510 to move to a range in which short-distance wireless communication of the ID card recognition unit 190 can be performed. For example, Near Field Communication (NFC) may be used as the short-distance wireless communication. The NFC refers to a contactless short-distance wireless communication method which uses a frequency band of 13.56 Mz. According to the NFC technique, in response to the ID card 510 and the ID card recognition unit 190 being close to each other within a short distance of about 10 cm, data may be exchanged.

The communication interface is configured to communicate with various kinds of external devices according to various communication methods. In particular, the communication interface may receive printing data from the host device 100′.

The communication interface may include various communication chips such as a WiFi chip, a Bluetooth chip, an NFC chip, and a wireless communication chip. In this case, the WiFi chip, the Bluetooth chip, and the NFC chip communicate in a WiFi method, a Bluetooth method, and an NFC method, respectively. The NFC chip refers to a chip which operates in an NFC method using a band of 13.56 MHz from among various RF-ID frequency bands such as 135 kHz, 13.56 MHz, 433 MHz, 860-960 MHz, and 2.45 GHz. When the WiFi chip or the Bluetooth chip is used, a variety of connection information such as an SSID and a session key may be exchanged first, and communication may be established using the connection information, and then a variety of information may be exchanged. The wireless communication chip refers to a chip which communicates according to various communication standards such as IEEE, Zigbee, 3^{rd} Generation (3G), 3^{rd} Generation Partnership Project (3GPP), Long Term Evolution (LTE), and the like.

The printing data received from the host device 100′ via the communication interface may include user information of the host device. The controller 230 may identify the user information of the received printing data and may temporarily store the printing data in an account corresponding to the user.

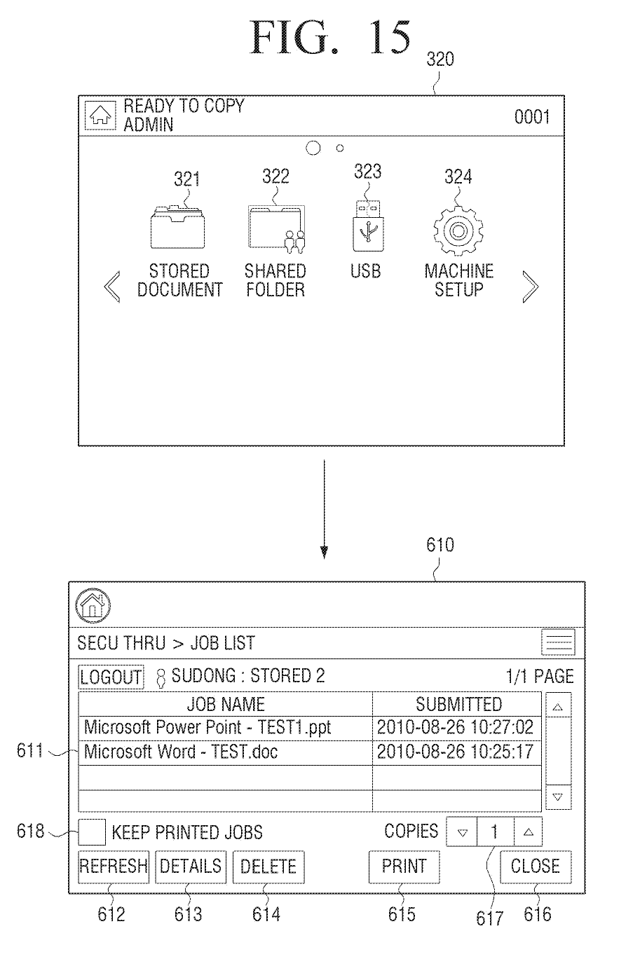

Thereafter, in response to the ID card 510 being tagged through the ID card recognition unit 190, the controller 230 may authenticate the user, and, in response to the printing data being stored in the account of the authenticated user, may control the display 250 to display a menu screen (fourth menu screen) including a list of stored printing data. An example of the fourth menu screen is illustrated in FIG. 15.

In response to the printing data not being stored in the account of the authenticated user, a screen pre-set by the user may be displayed or the above-described second menu screen (menu screen for receiving a control command related to the function which requires a document) may be displayed.

Herein, the screen pre-set by the user refers to a screen which is formed by directly selecting function menus frequently used by the user. For example, when the function frequently used by the user is duplex printing, a menu screen including a function menu corresponding to duplex printing may be set to be displayed on the display 250 in response to the ID card 510 being tagged. In response to the setting function menu 316 included in the menu screen being selected, a screen for receiving user settings described above may be displayed.

FIG. 15 is a view to illustrate a screen including a list of printing data displayed on the display 250 according to an exemplary embodiment of the present invention.

Referring to FIG. 15, when the user approaches the image forming device 200′ in order to receive the output of printing data transmitted from the host device 100′, the user may not carry any document on user's hands. In this case, the controller 230 may determine that the user does not carry a document using image data of the user photographed through the photographing unit 240.

According to the result of the determining, the controller 230 may control the display 250 to display the menu screen 320 for receiving a control command related to the function which does not require a document, as shown in FIG. 15.

Thereafter, in response to the user being authenticated by tagging the ID card, inputting the ID and the password, recognizing a fingerprint, recognizing a voice, or the like, the controller 230 may control the display 250 to change the menu screen 320 to a menu screen 610 including a list of printing data, and display the menu screen 610.

The menu screen 610 may include a list region 611 including a list of printing data, a refresh menu 612, a details menu 613, a delete menu 614, a print menu 615, a close menu 616, a menu 617 for selecting the number of copies, and a check box 618 for selecting whether to keep printing data after printing, and the like. The list region 611 may include a list of printing data which are generated according to user manipulation on the host device 100′. On the list region 611, printing data to be printed is selected, and in response to the print menu 615 being selected, the selected printing data is outputted.

In the above description, the embodiment including the step of displaying the menu screen 310 according to the result of analyzing image data of the user photographed (first step), and the step of changing the menu screen 310 to another menu screen 610 according to user authentication and displaying the menu screen 610 (second step) has been described with reference to FIG. 15. According to another exemplary embodiment, the first step of analyzing image data may be omitted. That is, the user may turn off the photographing unit 240 in order to reduce power consumption, and, in this case, the controller 230 may control the display 250 to display the screen including the list of printing data directly in response to the user being authenticated.

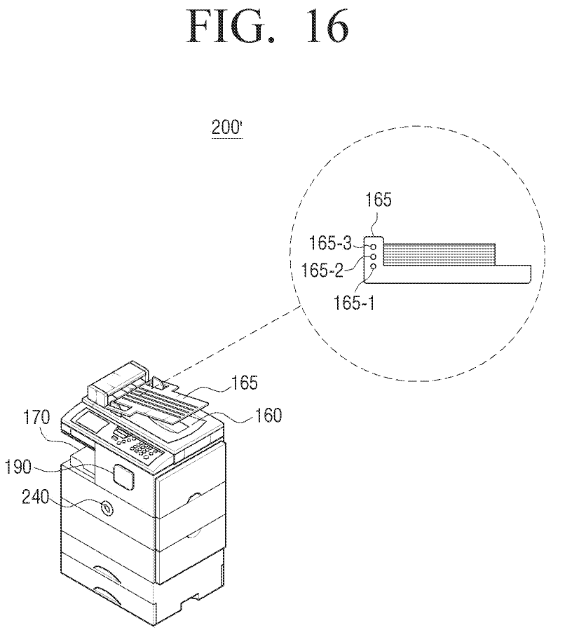

FIG. 16 is a view showing an image forming device 200′ according to an exemplary embodiment of the present invention.

Referring to FIG. 16, the image forming device 200′ may include a photographing unit 240, an ID card recognition unit 190, an Automatic Document Feeder (ADF) 165, a first output box 160, and a second output box 170.

The ADF 165 is configured to automatically provide a document laid thereon into the image forming device 200′. The ADF 165 may include a roller for feeding the document laid thereon sheet by sheet. In particular, the ADP 165 may have a plurality of proximity sensors 165-1, 165-2, 165-3 disposed therein. In response to a document being laid on the ADF 165, the controller 230 may detect the height of the document through the plurality of proximity sensors 165-1, 165-2, 165-3 arranged in the vertical direction, and may change a function menu displayed on a menu screen according to the detected height and display the function menu.

Alternatively, the ADF 165 may include a gravity sensor (not shown) for detecting the weight of a document, and the controller 230 may estimate the height of the document according to the detected weight of the document and may change a function menu displayed on a menu screen according to the estimated height and display the function menu.

For example, in response to it being determined that the height of the document is greater than or equal to a predetermined height through the plurality of proximity sensors 165-1, 165-2, 165-3 or the gravity sensor, the controller 230 may control the display 250 to display a screen including a function menu corresponding to a function for a document of several sheets. Herein, the function for a document of several sheets may be a function of printing a plurality of documents on a single sheet of paper, a function of setting an order of outputting a plurality of documents, a duplex printing function, or the like

On the other hand, as described above, in response to it being determined that the user carries a document, the controller 230 may control the display 250 to display a menu screen including a function menu related to the function which requires a document. Furthermore, in response to it being determined that the height of the document is greater than or equal to the predetermined height, the controller 230 may control the display 250 to display the menu screen further including the function menu for the document of several sheets, or may control the display 250 to display a screen including only the function menu for the document of several sheets.

Even in response to the photographing unit 240 being turned off, the ADF 165 may detect the presence of a document using the plurality of proximity sensors 165-1, 165-2, 165-3 or the gravity sensor. Therefore, the controller 230 may control the display 250 to display the function menus requiring a document.

The first output box 160 and the second output box 170 are places where the document used in the job is discharged after the job is completed. According to an exemplary embodiment of the present invention, a proximity sensor or a gravity sensor may be disposed in at least one of the first output box 160 and the second output box 170, for detecting whether the document is stacked or not.

For example, after the user is authenticated through the ID card recognition unit 190 and a function requested by the authenticated user is performed, the controller 230 may determine whether the document used for performing the requested function or the document used for the job is stacked or not using the sensor installed in the first output box 150 or the second output box 170.

As a result of the determining, in response to it being determined that the document remains (is stacked) in the first output box 160 or the second output box 170, the controller 230 may notify a terminal device corresponding to the authenticated user of information of the stacked document through the communication interface (not shown). For example, the terminal device of the user may display a message saying “Please pick up the document from the multifunction printer located in the marketing department on the fifth floor.” In this case, the terminal device of the user may be a mobile terminal device such as a mobile phone, a smart phone, a tablet PC, or the like, or may be a desktop PC or a TV of the user. The user may register information of the user's terminal device (for example, an IP address, a phone number, or the like) at the image forming device 200′ in advance, and may receive the above-described notification message.

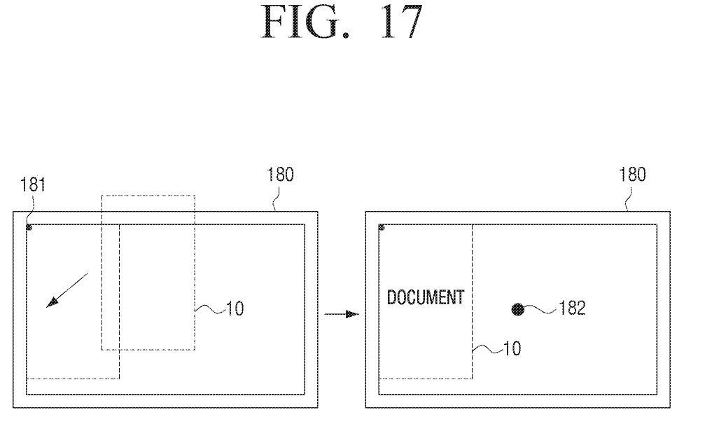

FIG. 17 is a view to illustrate a flatbed 180 of the image forming device 200′ according to an exemplary embodiment of the present invention. The flatbed 180 refers to a place where a document 10 is placed to be scanned, and may be called a “scan glass.”

The flatbed 180 may include a proximity sensor 181 and the controller 230 may detect placement of a document through the proximity sensor 181. Specifically, at least one proximity sensor 181 may be disposed in the flatbed 180.

In response to it being determined that a document 10 is placed on the flatbed 180, the controller 230 may generate a photographing image on the entire area of the flatbed where the document is placed using a photographing element 182 disposed under the flatbed. Herein, the photographing element 182 may be a CCD camera.

The controller 230 may calculate the size of the document 10 relative to the size of the flatbed 180 using the generated photographing image, and may analyze the type of the document 10 based on the result of the calculating. For example, the image forming devices 200′ may register various types of documents, such as an identification, newspaper, a pamphlet, and the like, and the controller 230 may detect the type of the document corresponding to the most similar value to a resulting value of the calculating from among the registered types of the documents.

The controller 230 may control the display 250 to change a function menu displayed on a menu screen according to the analyzed type of the document, and display the function menu. For example, in response to the type of the document being analyzed as an ID card, the controller 230 may control the display 250 to display an ID card copy function. In response to the type of the document being analyzed as newspaper, the controller 230 may control the display 250 to display a background adjustment function and a back image removing function. In response to the type of the document being analyzed as a pamphlet, the controller 230 may control the display 250 to display a function of copying both pages on paper separately, a function of copying only one page of both pages, a function of setting a copy order of both pages, and a function of erasing a middle or edge area of both pages.

As described above, in response to it being determined that the user carries a document, the controller 230 may control the display 250 to display a menu screen including a function menu related to the function which requires a document. Furthermore, in response to the type of the document being analyzed, the controller 230 may control the display 250 to display the menu screen further including a function menu suited to the analyzed type of the document, or may control the display 250 to display only the function suited to the analyzed document.

Even in response to the photographing unit 240 being turned off, flatbed 180 may detect the presence of a document using the proximity sensor 180. Therefore, the controller 230 may control the display 250 to display the function menus requiring a document.

According to another exemplary embodiment of the present invention, the controller 230 may detect an input of a network cable or a portable storage medium to the image forming device 200′. In response to such an input being detected, the controller 230 may control the display 250 to display a network setting recommendation screen, and may control the display 250 to display a print function menu using the portable storage medium. In response to the portable storage medium being a USB, a menu screen including the menu 323 of printing a document stored in a USB as shown in FIG. 13 may be displayed on the display 250.

According to an exemplary embodiment, the controller 230 may process and output printing data according to various conditions (option policy) set by the user. That is, in response to printing data being received, the controller 230 may perform a printing job by reflecting a predetermined option policy.

For example, the option policy may be a policy for allowing only a monochrome output regarding printed matter which is outputted at a specific time. In this case, when the printing data received from the host device 100′ aims at color printing, the option policy may be applied at the specific time and monochrome printing may be performed. In another example, in response to printing a document of several sheets being requested at a specific time, the controller 230 may apply duplex printing according to the option policy.

According to another exemplary embodiment of the present invention, an option policy may be set so as to reflect a different print option according to a type of a file included in printing data. For example, referring back to FIG. 15, in response to the user selecting a doc file in the list region 611 including the list of printing data and selecting the print menu 615, the controller 230 may apply a monochrome output mode and perform printing. Alternatively, in response to a ppt file being selected and then the print menu 615 being selected, the controller 230 may apply a color output mode and perform printing. That is, the option policy may be set such that a color output is allowed for a specific file and is not allowed for a specific file.

According to an exemplary embodiment of the present invention, the controller 230 may scan a document and determine whether the document is a text document or an image document. In response to the document being determined to be the text document, the controller 230 may apply a monochrome output mode and a power-saving print mode according to an option policy, and, in response to the document being determined to be the image document, the controller 230 may apply a color output mode and a high quality print mode according to an option policy.

The option policy may include a policy for saving power of the image forming device 200′. For example, the user may set the time required to enter a power saving mode as 30 minutes in time during which the image forming device 200′ is most frequently used, and may set the time required to enter the power saving mode as 1 minute in time during which the image forming device 200′ is least frequently used.

The controller 230 may add information on the above-described option policy to printing data which is created in a Print Job Language (PJL) format, and may generate final printing data. The printing data created in the PJL format may include information on a destination of the printing data, an email address to which the printing data is transmitted after being printed, and a server in which the printing data is stored after being printed.

Specifically, the controller 230 may add a COMMENT which should be added to a PJL COMMENT according to the option policy, and generate final printing data. As described above, the controller 230 may additionally include duplex printing option information to printing data which is received at specific time, such that duplex printing is always applied to the printing performed at the specific time.

In addition, the image forming device 200′ may include a fax function. In response to fax data being received, the controller 230 may analyze the fax data. According to a result of the analyzing, the controller 230 may move the received fax data to a spam storage or may retransmit the fax data to an appropriate department according to the content of the fax data. In this case, the fax data may include an identifier for allowing the controller 230 to identify what content is included in the fax data. For example, the fax data may include information on a fax transmitter, and accordingly, the controller 230 may determine whether to move the received fax data to the spam storage or not.

According to various exemplary embodiments of the present invention described above, the image forming device 200 may grasp a user's job intention and may recommend an appropriate function according to the job intention to the user or may automatically perform an appropriate function. Accordingly, the user can easily use various functions provided by the image forming device 200′ without going through a complicated process.

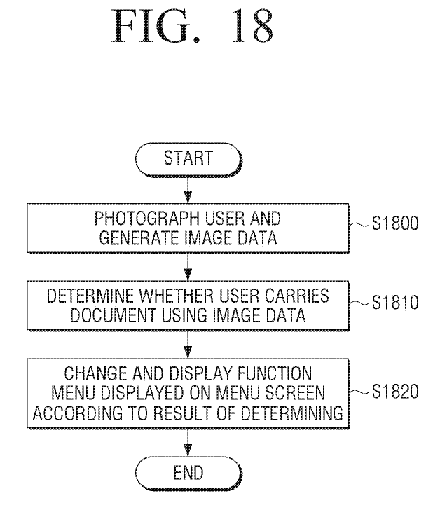

FIG. 18 is a flowchart to illustrate an image forming method of the image forming device according to an exemplary embodiment of the present invention.

Referring to FIG. 18, first, the controller 230 photographs a user using the photographing unit 240 and generates image data (S1800). In this case, the image data may be video data or photo data. In addition, the controller 230 determines whether the user carries a document or not using the image data (S1810).

In addition, the controller 230 may change a function menu displayed on a menu screen according to a result of the determining and display the function menu (S1820).

The various exemplary embodiments described above through FIGS. 10 to 17 may be added to the image forming method of the image forming device described above as they are, or may be changed within a range in which a person skilled in the art could make a change obviously and may be added. Accordingly, the various exemplary embodiments of the image forming method of the image forming device which can be derived will not be described in detail regarding the same features as described above.

The image forming method of the image forming device according to the above-described various exemplary embodiments may be stored in a non-transitory readable medium. The non-transitory readable medium may be mounted and used in various devices.

The non-transitory readable medium refers to a medium that stores data semi-permanently rather than storing data for a very short time, such as a register, a cache, a memory or like, and is readable by an apparatus. Specifically, the non-transitory readable medium may be a CD, a DVD, a hard disk, a Blu-ray disk, a USB, a memory card, a ROM or the like.

While preferred embodiments of the present invention have been illustrated and described, the present invention is not limited to the above-described specific embodiments. Various changes can be made by a person skilled in the art without departing from the scope of the present invention claimed in claims, and also, changed embodiments should not be understood as being separate from the technical idea or prospect of the present invention.

What is claimed is:

1. A host device comprising:
an input unit which receives a control command for performing a predetermined event;
a communication interface which communicates with an image forming device; and
a controller which, in response to the received control command being related to control of the image forming device, transmits, to the image forming device via the communication interface, a state change command for changing the operation state of the image forming device, and performs the predetermined event corresponding to the received control command.

2. The host device of claim 1, wherein the predetermined event is at least one of a driving event of a printer driver, a driving event of a predetermined application, a printer selection event, a print option setting event, and a printing file selection event.

3. The host device of claim 1, wherein the controller generates printing data and transmits the generated printing data to the image forming device to which the state change command has been already transmitted via the communication interface.

4. The host device of claim 1, wherein, in response to the predetermined event being the print option setting event, the controller generates printing data reflecting the set print option.

5. The host device of claim 1, wherein, in response to the predetermined event being the printer selection event, the controller transmits the state change command to an image forming device corresponding to the selected printer.

6. The host device of claim 1, wherein the state change command is a command for changing the operation state of the image forming device from a power saving state to a non-power saving state.

7. The host device of claim 1, wherein, in response to a print command not being inputted within a predetermined time after the state change command has been transmitted, the controller transmits a command for changing the operation state of the image forming device to a power saving state to the image forming device via the communication interface.

8. The host device of claim 1, wherein the controller generates printing data for a pre-selected file before a print command is inputted.

9. The host device of claim 8, wherein, in response to a plurality of files being pre-selected, the controller generates printing data for a predetermined number of files from among the pre-selected plurality of files.

10. The host device of claim 9, wherein, in response to the print command being inputted, the controller generates printing data for files for which printing data has not been generated from among the pre-selected plurality of files.

11. A printing control method of a host device connected with an image forming device, the method comprising:
receiving a control command for performing a predetermined event;
in response to the control command being related to control of the image forming device, transmitting, to the image forming device, a state change command for changing the operation state of the image forming device; and
performing the predetermined event corresponding to the received control command.

12. The printing control method of claim 11, further comprising:
generating printing data; and
transmitting the generated printing data to the image forming device to which the state change command has been transmitted.

13. The printing control method of claim 11, wherein, in response to the predetermined event being a printer selection event, the transmitting the state change command to the image forming device comprises transmitting the state change command to an image forming device corresponding to the selected printer.

14. The printing control method of claim 11, wherein the state change command is a command for changing the operation state of the image forming device from a power saving state to a non-power saving state.

15. The printing control method of claim 11, further comprising, in response to a print command not being inputted within a predetermined time after the state change command has been transmitted, transmitting a command for changing the operation state of the image forming device to a power saving state to the image forming device.
